(19) United States
(12) Patent Application Publication
(10) Pub. No.: US 2009/0200703 A1
(43) Pub. Date: Aug. 13, 2009

(54) METHOD FOR PRODUCING MOULDED BRICKS WITH FIBRES

(75) Inventor: Jürgen Halm, Dielheim (DE)

Correspondence Address: FOLEY AND LARDNER LLP;SUITE 500, 3000 K STREET NW, WASHINGTON, DC, 20007, US

(73) Assignee: LUCCON Lichtbeton GmbH, Klaus (AT)

(21) Appl. No.: 12/280,141

(22) PCT Filed: Feb. 15, 2007
(86) PCT No.: PCT/EP07/01302

§ 371 Date: Nov. 14, 2008

(30) Foreign Application Priority Data
Feb. 21, 2006 (DE) 10 2006 007 920.5

(51) Int. Cl. B28B 1/16; B29C 43/18

(52) U.S. Cl. 264/256; 425/404

(57) ABSTRACT

The present invention relates to a method and device for producing moulded bricks made of hydraulically binding materials and with fibres, mats, bonded fabrics and wovens embedded therein, a formwork (1) composed of a frame (2) and a vertically movable base (3) being used. According to the invention, the base (3) is first adjusted to a height s below the top edge of the formwork, said height corresponding to the height of a layer of hydraulically binding material (5) and fibres, mats, bonded fabrics and wovens (6). The formwork (1) is then filled up to its upper edge with hydraulically binding material (5) by means of a mortar carriage (4). The fibres, mats, bonded fabrics and wovens are inserted into the fresh hydraulically binding material (5) in the desired orientation and the base (3) of the formwork (1) is subsequently lowered by a value corresponding to the height s. These steps are repeated until the desired height of the moulded brick is reached or until the base (3) of the formwork (1) may not be lowered further.

The present invention relates to the production of molded blocks from a hydraulically setting compound, in which fibers, in particular optical fibers, are embedded.

Molded blocks of hydraulically setting compounds with integrated fibers have long been known. Hydraulically setting compounds, also referred to hereafter as a matrix, are understood as meaning concrete, fine-grained concrete, mortar, gypsum and similar materials, which generally contain a hydraulic binder, aggregates, additives, admixtures and water. Within the scope of the invention, reference is made to molded blocks, which are intended to include not only the classic blocks with a square or rectangular base area but also those with a triangular, trapezoidal or rhomboidal base area and all conceivable round forms, such as a circle, ellipse, etc.

The advancing development of optical fibers is increasingly lowering their costs. In addition, the demand for exclusive design effects is increasing. Under these boundary conditions, molded blocks of hydraulically setting or cast compounds in which optical fibers are embedded in such a way that light penetrates through the bricks have been proposed in DE 93 10 500 U and WO 03/097954.

However, the production process claimed in WO 03/097954 is complex and unsuitable for production on an industrial scale. It is important to achieve a constant supply and distribution of the matrix in the formwork. The maintenance of constant thicknesses for the individual layers of matrix or fiber is also problematic. DE 93 10 500 U says nothing about the question of production.

The object of the present invention was therefore to find a process by which fibers can be incorporated in molded blocks, in particular of concrete, with a fixed orientation.

This object is achieved by a process and a device for producing molded blocks from hydraulically setting compounds (matrix) and fibers embedded therein, in which a formwork comprising a frame with a vertically movable base is used. The base of the formwork is initially set to a defined height below the upper edge of the frame, filled with hydraulically setting compound, the fibers are placed on in the desired direction and incorporated into the compound, and then the base is lowered by a predetermined amount. The steps are repeated until the desired height of the molded block is achieved.

The molded block produced in this way can also be used to obtain smaller blocks by means of cutting it up transversely and longitudinally with respect to the direction of the fibers.

Cement is suitable in particular as the hydraulic binder for the matrix. Suitable cements are, for example, Portland cement, Portland slag cement, Portland fly-ash cement, Portland limestone cement, Portland composite cement and blast-furnace cement. Portland cement and Portland slag cement are preferred.

In a way known per se, the matrix may contain natural and/or artificial aggregates, admixtures and/or additives.

Admixtures are, for example, natural and artificial pozzolans, color pigments, polymer dispersions, stone dusts, etc.; typical amounts are, for example, 3 to 8% by weight for color pigments and up to 30% by weight for fly ash, stone dusts, etc.

Additives are, for example, air-entraining agents, liquefiers, plasticizers, accelerators, retarders, etc. If present, amounts of each of up to 5% by weight, in individual cases of up to 10% by weight, are used.

In principle, sand, gravel or stone chippings are used. To achieve a uniform and dense distribution of the light-conducting fibers, sand mixtures with a maximum size of aggregate of approximately 2 mm have proven successful. The mass ratio of cement and sand is generally between 1:1 and 1:3.

The fibers are, in particular, optical fibers, so that the molded blocks produced according to the invention are transmissive to light in the direction of the incorporated fibers. The process and the device are, however, also ideally suited to the embedding of other fibers, in particular where it is important that the arrangement and orientation of the fibers within the molded block can be set in a specific manner.

Accordingly, textile glass fibers, plastic fibers, carbon fibers, natural fibers, etc., come into consideration as fibers. Instead of individual fibers, it is also possible to incorporate mats, bonded fabrics, rovings or, with particular preference, woven fabrics, referred to hereafter as fabrics for short.

It goes without saying that the fibers and the hydraulically setting compound must be compatible with one another, as is the case for example with the known optical fibers of silicate glass and cement.

Furthermore, the proportion of the fibers in the matrix must be appropriately set to ensure the required strength and load-bearing capacity of the molded block. In the case of optical fibers, suitable proportions are, for example, 2 to 10% by volume, preferably 5 to 8% by volume, with which satisfactory light transmission is achieved.

The formwork is preferably to be adapted in width, length and depth to the desired dimensions of the molded blocks. For example, dimensions of 50 cm×200 cm are suitable. The depth, which determines the maximum height of the molded block, may be, for example, 50 cm. It is advantageous for the process and the device of the invention that the height can be freely varied within the range of the minimum height, determined by the height of a layer of hydraulic compound and fibers, and the depth of the formwork.

The formwork should consist of a material, or at least be provided inside with a material, from which the matrix becomes adequately detached to ensure damage-free demolding. The formwork materials that are used for precast concrete units are accordingly suitable. The use of release agents, as are likewise known from the production of precast units, is possible.

The adjustment of the base may be performed in a way no per se by means of a spindle drive, a hydraulic mechanism or the like. It is advantageous for the demolding, and for cleaning that may be necessary, if the side walls of the formwork are foldable.

Preferably used for introducing the matrix is a device such as that already known as a mortar carriage. Mortar carriages are used for the laying of large-format masonry units (bricks, aerated concrete, sand-lime blocks) by the thin-bed fixing technique (thin layer of mortar of a thickness of about 5 mm). This involves applying the masonry mortar to the upper side of each course of blocks with the aid of a mortar carriage. The mortar carriage is a rectangular metal box which is open at the top and bottom and the width of which coincides with the width of the blocks being used. It is filled from above with mortar and subsequently pulled over the upper edge of a course of blocks in the longitudinal direction of the wall. A thin layer of mortar is applied to the upper side of the blocks via the open underside of the box and a defined gap.

Alternatively, the matrix may also be applied by means of a spraying device.

In a particularly preferred embodiment, the fibers or fabrics are kept on one or more rollers and, from there, are laid onto the compound and appropriately cut to the required length. This may preferably involve using a suitable device to stretch the fibers over the molding length and fix them, which advantageously avoids displacement of the fibers within the compound. Suitable for this, for example, is a clamping device, with which the fibers or fabrics are fixed on both sides of the formwork.

Alternatively, in particular in the case of stiff fibers, fibers that are already cut to length may be placed into the formwork.

The incorporation of the fibers or fabrics, and possibly simultaneous deaeration of the compound, is expediently performed by surface or external vibrators. A smoothing device with an integrated vibrating device can likewise be used.

In a preferred embodiment, the mortar carriage or the spraying device may be made to pass over the formwork and/or the formwork is moved under the mortar carriage or the spraying device. Particularly high rates of production can be realized if the formwork and the mortar carriage or at the spring device are made to move.

In a particularly preferred embodiment, the fibers or fabrics are introduced by the mortar carriage and so are brought into the formwork together with the hydraulically setting compound. This expediently involves deaeration of the compound by means of an internal or external vibrator on the mortar carriage.

With the process and the device according to the invention, patterns can also be created in the molded block. For this purpose, the fibers may be entirely or partially omitted in one or more layers.

The invention is to be explained in more detail on the basis of the accompanying figures, without however being restricted to the configurations described. Unless otherwise indicated, all values given in % refer to the weight.

In the figures:

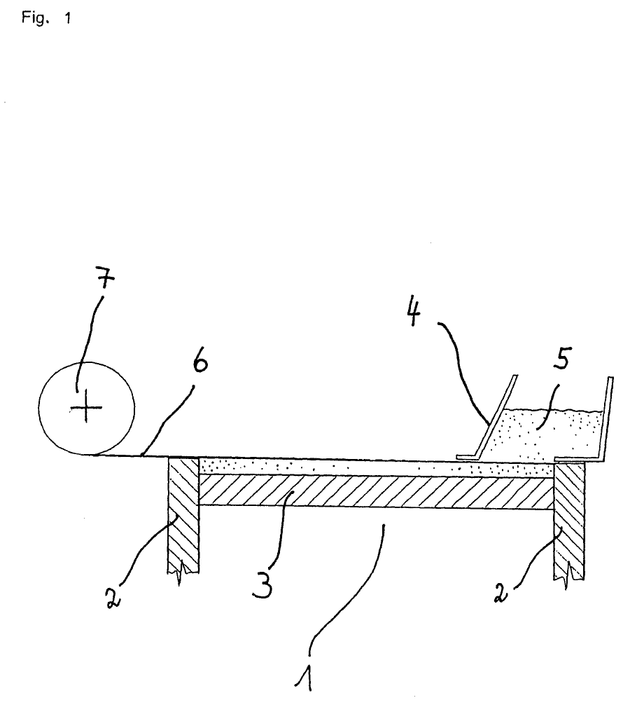

FIG. 1 shows a diagram of a device according to the invention

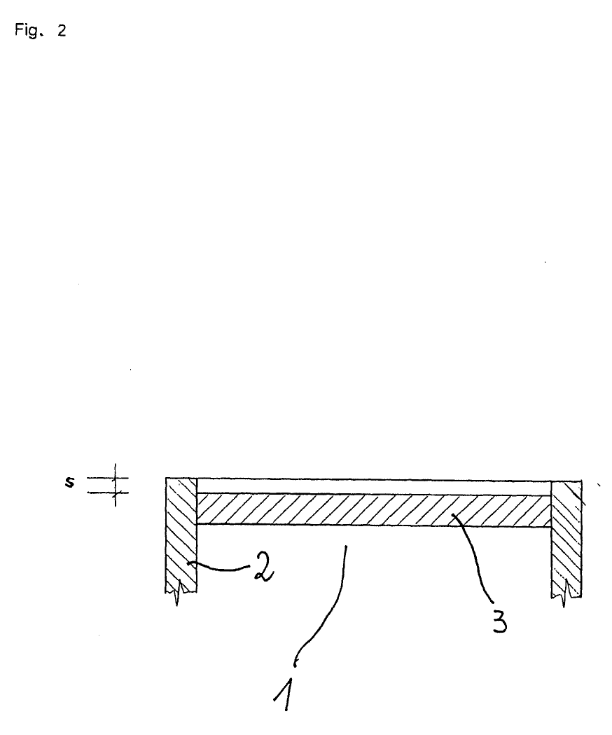

FIG. 2 shows a diagram of a formwork at the beginning of production

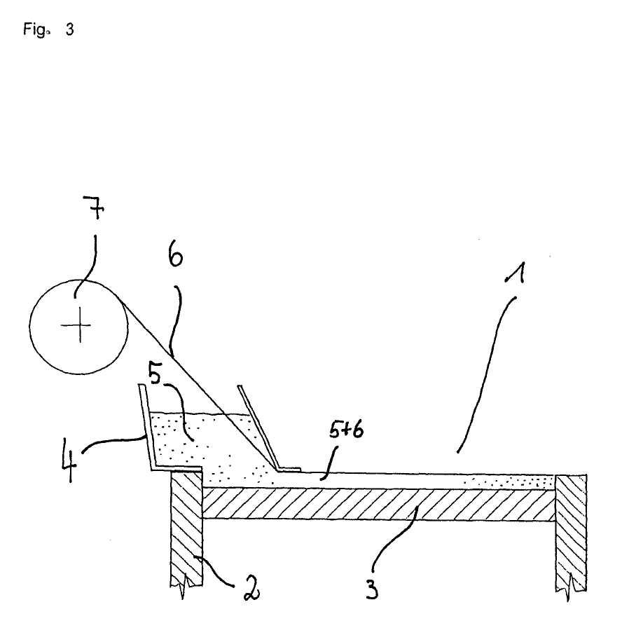

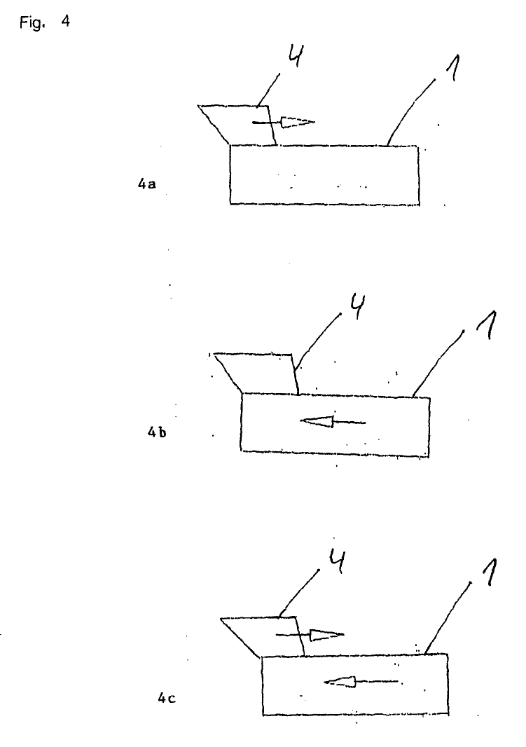

FIG. 3 shows a diagram of an alternative device according to the invention

FIG. 4 shows variants of the process sequence

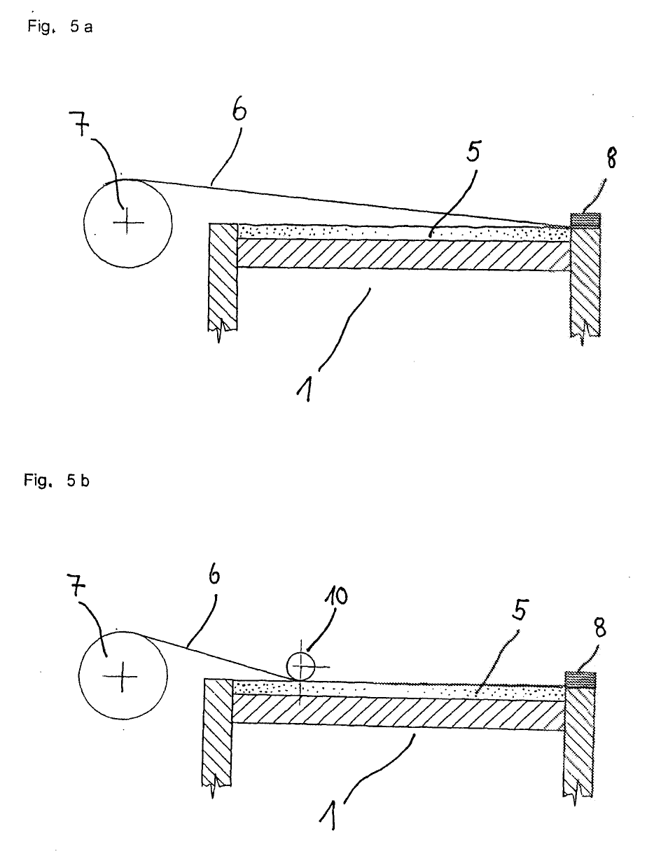

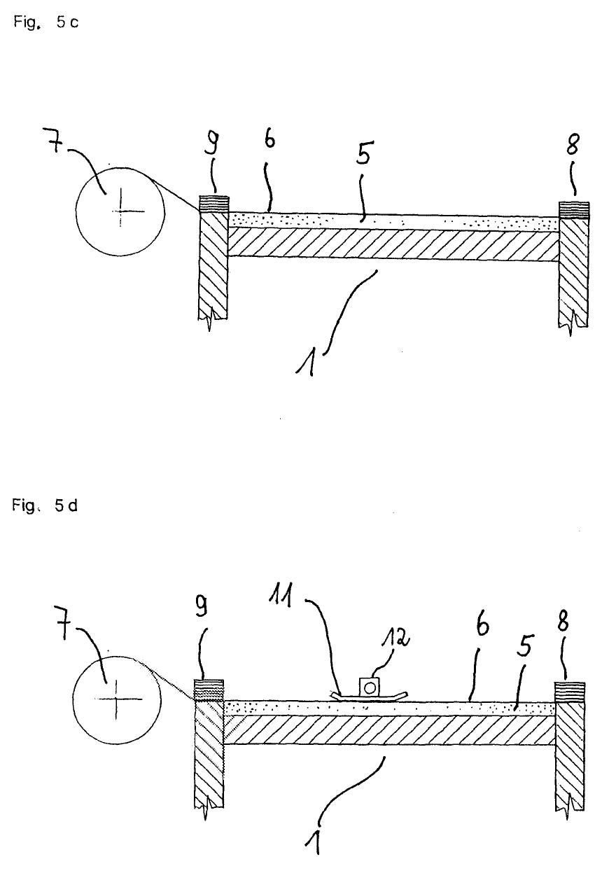

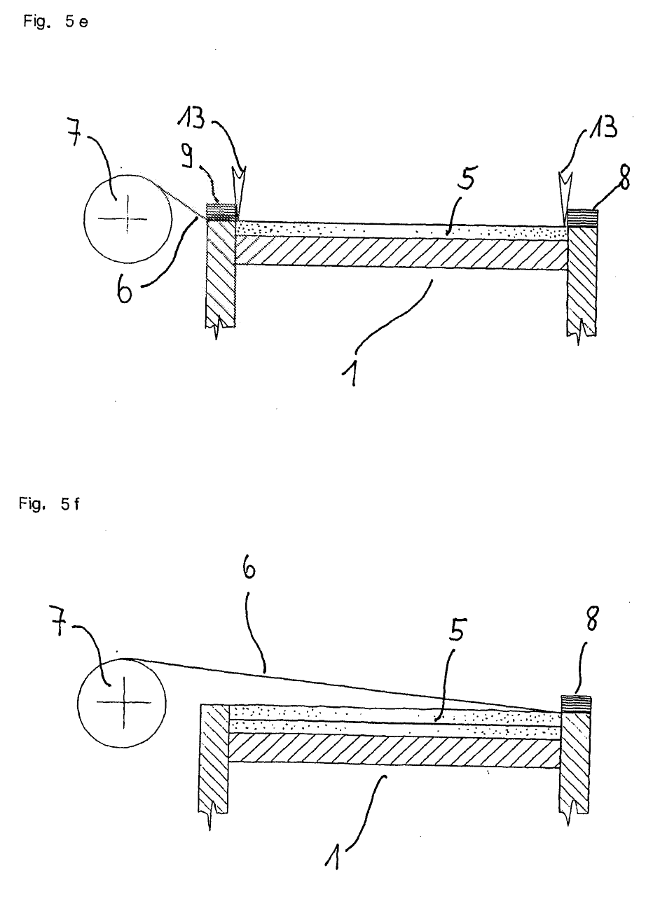

FIG. 5a-f show diagrams of a device according to the invention with a clamping device for fixing the fibers or fabrics in various stages of the process.

In FIG. 1, a device according to the invention is schematically represented. It comprises the formwork 1 made up of a frame 2 and a vertically movable base 3. Also provided is a mortar carriage 4, which fills the hydraulically setting compound 5 into the formwork 1 in a controllable amount. The fibers 6 are unrolled from a roller 7. Not represented are the drive of the base 3, the devices for cutting the fibers 6 to length and the smoothing device for incorporating the fibers.

According to the invention, at the beginning of production the base 3 of the formwork 1 is below the upper edge of the formwork with a defined difference in height s. This difference in height s corresponds to the height of a layer of hydraulically setting compound 5 and fibers 6. The mortar carriage 4 travels over the formwork 1 along the upper edge of the latter and thereby fills it with an amount of matrix 5 that can be exactly set. Subsequently, the fibers 6 required for one layer are placed onto the fresh surface of the matrix 5, either as individual fibers or as fabrics, incorporated with the smoothing device and cut to length.

For the next step, the base 3 of the formwork 1 is lowered by the height s of a layer comprising matrix 5 and fibers 6 and the filling operation is repeated in the same way. During the filling operation, the formwork 1 may be vibrated from the outside to deaerate the matrix 5, or compaction is performed by means of the smoothing device.

In FIG. 2, a formwork 1 of a device according to the invention is represented, the base 3 being in the uppermost position, which is set at the beginning of production.

FIG. 3 shows a variant of the device according to the invention, the same parts being denoted by the same designations. Here, the fibers 6 are unrolled from the roller 7 and incorporated in the matrix 5 in the mortar carriage 4. The filling with matrix 5 and fibers 6 is accordingly performed simultaneously. In the case of this embodiment, the mortar carriage 4 is preferably provided with an internal or external vibrator for deaerating the matrix 5; this dispenses with the need for a smoothing device, but it may also be integrated on the mortar carriage.

In FIG. 4, three variants of the device are represented. In the case of the first variant, represented in FIG. 4a, the mortar carriage 4 is movable and travels over the formwork 1, in order to fill it with the compound 5. In the case of the second variant, represented in FIG. 4b, the mortar carriage 4 is fixedly arranged and the formwork 1 is movable, so that the formwork 1 is made to pass along under the mortar carriage 4 for filling it with the compound 5. In the case of the third variant, represented in FIG. 4c, both the mortar carriage 4 and the formwork 1 are movable and are moved with respect to one another for the filling with the compound 5 and possibly also the fibers 6. This allows an increase in the production rate.

In FIG. 5a-f, the process sequence is shown and a corresponding device is schematically represented, a clamping device fixing the fibers or fabrics during the smoothing and cutting to length. The process sequence and the basic construction correspond to that of FIG. 1. Once the position of the light-conducting glass fibers 6 (individual fiber strands or fabrics) have been placed onto the fresh matrix layer 5, the glass layer 6 is fixed directly outside the formwork 1 on one side by a clamping device 8 (see FIG. 5a). Then, as shown in FIG. 5b, the glass layer 6 is pressed onto the surface of the matrix 5 by a pressing roller 10. In FIG. 5c it can be seen how the other side of the glass layer 6 is then also fixed by a clamping device 9. The clamping device 8, 9 may in this case be positioned in such a way that a certain tension is exerted on the glass layer 6. Then a smoothing and compacting operation is performed by a smoothing plate 11, which is represented in FIG. 5d. By analogy with the procedure in the case of a road paver, additional compaction energy can in this case be applied via the smoothing plate 11 by means of a vibrator 12.

Subsequently, as represented in FIG. 5e, the glass layer 6 is severed between the clamping devices 8 and 9 by a suitable sawing device 13. The clamping devices 8, 9 thereby prevent displacement of the fiber layer 6 in the fresh matrix 5 both during the smoothing and compacting and during the severing of the fibers 6.

After the severing, the clamping device 8, 9 is released, the base 3 of the formwork 1 is lowered and it is filled again with matrix 5. Then the operation is repeated, see FIG. 5f.

The invention has been explained on the basis of the example of a rectangular block; other forms with triangular, trapezoidal, polygonal, round or curved base areas can also be analogously obtained by corresponding choice of the form of formwork. The walls may be made perpendicular or else inclined with respect to the base area. In addition, it is possible by mechanical finishing, for example sawing, to adapt the outer contour more specifically to desired forms.

Although the process has proven to be particularly successful in the case of light-transmitting blocks, it can also be advantageously used in the case of other fibers for which exact alignment is desirable.

### List of Designations

1 formwork
2 frame
3 base
4 mortar carriage
5 hydraulically setting compound/matrix
6 fibers/fabrics
7 roller (storing of the fibers/fabrics)
8 clamping device
9 clamping device
10 pressing roller
11 smoothing plate
12 vibrator
13 sawing device

1. A process for the production of molded blocks from hydraulically setting compounds and fibers, mats, bonded fabrics or woven fibers embedded therein, characterized in that a formwork made up of a frame and a vertically movable base is used, wherein
a) the base is set to a height s below the upper edge of the formwork that corresponds to the height of a layer of hydraulically setting compound and fibers
b) the formwork is filled up to the upper edge with hydraulically setting compound by means of a mortar carriage or a spraying device
c) fibers, mats, bonded fabrics or woven fabrics are placed into the fresh hydraulically setting compound in the desired orientation, stretched over the upper edge of the formwork by a clamping device and fixed and are then cut to length
d) the base of the formwork is lowered by a height s, which corresponds to the height of a layer of hydraulically setting compound and fibers, and
steps b) through d) are repeated until the desired height of the molded block is reached and/or the base of the formwork cannot be lowered any further.

2. The process as claimed in claim 1, wherein the hydraulically setting compound is a cement, to which aggregates, additives and or admixtures are possibly added.

3. The process as claimed in claim 2, wherein the hydraulically setting compound is a Portland cement, Portland slag cement, Portland fly-ash cement, Portland limestone cement, Portland composite cement, blast-furnace cement or a mixture thereof and contains an aggregate, preferably sand.

4. The process as claimed in claim 1, wherein the fibers, mats, bonded fabrics or woven fabrics are optical fibers, mats, bonded fabrics or woven fabrics.

5. The process as claimed in claim 1, wherein the fibers, mats, bonded fabrics or woven fabrics are unrolled from a roller and placed onto the hydraulically setting compound.

6. The process as claimed in claim 1, wherein, after being placed in, the fibers are incorporated in the hydraulically setting compound by a smoothing device.

7. The process as claimed in claim 1, wherein, instead of steps b) and c), the fibers are introduced into the hydraulically setting compound in the mortar carriage and the fibers are filled together with the hydraulically setting compound into the formwork up to the upper edge.

8. The process as claimed in claim 7, wherein the hydraulically setting compound is deaerated in the mortar carriage by an internal or external vibrator.

9. A device for the production of molded blocks from hydraulically setting compounds and fibers, mats, bonded fabrics or woven fabrics embedded therein, wherein it comprises a formwork made up of a frame and a vertically movable base as well as a mortar carriage or a spraying device, wherein a clamping device is provided for fixing the fibers, mats, bonded fabrics or woven fabrics.

10. The device as claimed in claim 9, wherein it comprises a smoothing device for incorporating the fibers, mats, bonded fabrics or woven fabrics in the hydraulically setting compound.

11. The device as claimed in claim 9, wherein an internal or external vibrator is provided on the formwork and/or the mortar carriage for deaerating the hydraulically setting compound.

12. The device as claimed in claim 9, wherein the mortar carriage or the spraying device can be moved over the formwork.

13. The device as claimed in claim 9, wherein the formwork can be moved under the mortar carriage or the spraying device.

14. The device as claimed in claim 9, wherein the mortar carriage or the spraying device and the formwork can be moved with respect to one another.

15. (canceled)

16. The device as claimed in claim 9, wherein the base of the formwork is adjustable by means of a spindle drive and/or a hydraulic mechanism.

17. The device as claimed in claim 9, wherein the frame of the formwork can be folded up.
